(19) United States
(12) Patent Application Publication
(10) Pub. No.: US 2002/0104370 A1
(43) Pub. Date: Aug. 8, 2002

(54) Ultrasonic sensor for detecting gas bubbles

(76) Inventors: Juergen Steger, Koerle (DE); Wolfgang Mosebach, Malsfeld (DE)

Correspondence Address: Vincent L. Ramik, DILLER, RAMIK & WIGHT, 7345 McWhorter Place; Suite 101, Annandale, VA, 22003, US

(21) Appl. No.: 10/051,017

(22) Filed: Jan. 22, 2002

(30) Foreign Application Priority Data
Jan. 20, 2001 (DE) 201 01 082.8

(51) Int. Cl. G01N 15/06

(52) U.S. Cl. 73/61.75; 73/19.03

(57) ABSTRACT

The ultrasonic sensor comprises an ultrasonic transmitter (11) and an ultrasonic receiver (12) between which an accommodating device (13) for a hose (14) is arranged. The hose is flattened between stamps (21, 22) thus being pressed against rigid concave forming areas (15, 16) where the hose bears in a gap-free manner upon the housing wall (17). The sound velocity in the housing (10) is approximately as large as in the material of the hose (14). In the liquid contained in the hose the sound velocity is considerably smaller. Parallel sound waves are refracted at the interface between hose material and liquid such that the sound waves converge. By concentrating the sound energy into the hose and onto the ultrasonic receiver (12) a high-energy received signal is generated. When air bubbles exist in the liquid, the received signal is attenuated.

### BACKGROUND OF THE INVENTION

The present invention relates to an ultrasonic sensor for detecting gas bubbles in a hose, the ultrasonic sensor comprising an ultrasonic transmitter and an ultrasonic receiver arranged on opposite sides of a hose-accommodating device.

It is common practice in the medical field to use ultrasonic sensors for detecting gas bubbles. The ultrasonic sensors comprise an ultrasonic transmitter and an ultrasonic receiver each having a piezoelectric element. The ultrasonic signal is fed through the measuring volume. Since liquids are good sound conductors but gases are poor sound conductors, the intensity of the received sound energy is inversely proportional to the gas amount contained in the measuring volume. A particular problem is the coupling of the ultrasonic energy to the hose containing the measuring volume. Even small air gaps between the hose outer wall and the sensor lead to total reflection.

In U.S. Pat. No. 4,722,224 an ultrasonic sensor is described where the accommodating device, in which the hose is inserted, comprises two membranes each defining a liquid-filled chamber. The two chambers are hingedly connected with each other. When the device is closed, the membranes are pressed, by the liquid pressure, against the outer surface of the hose such that they are in full contact surface with said outer hose surface. The ultrasonic transmitter transmits the ultrasound via the liquid to the ultrasonic receiver without any contact point existing in the sound path. Such an ultrasonic transmitter requires two liquid-filled chambers. It is expensive and susceptible to mechanical damage.

Another ultrasonic sensor is described in U.S. Pat. No. 4,418,565. This ultrasonic sensor comprises two silicone bodies arranged between transmitter and receiver, said bodies pressing against the hose from opposite sides and deforming the hose. The device is suitable only for one hose diameter each.

### SUMMARY OF THE INVENTION

It is an object of the present invention to provide an ultrasonic sensor which can be manufactured in an inexpensive manner and supplies a high signal output.

According to the present invention the device accommodating the hose comprises rigid concave forming areas which define a forming channel of an essentially oval cross-section. The hose is partly flattened, wherein the bending areas of the hose are in full contact surface with the forming areas of the accommodating device. At the bending areas the hose thus bears in an air-free manner upon the forming areas. Since the sound velocity in the hose material is normally larger than in the liquid contained in the hose, an acoustical lens is formed at the hose curvature at the interface between the hose and the liquid contained therein, which lens concentrates the sound and/or the ultrasound onto a focal point. Behind the focal point the sound waves diverge again, and they are parallelled by the opposite acoustical lens. Due to the lens action of the partly flattened hose scattering losses of the sound energy are prevented. Further, all sound waves have the same traveling times on their way from the ultrasonic transmitter to the ultrasonic receiver thus arriving in phase at the receiver.

The ultrasonic sensor is easy to manufacture. It does not require any liquid chambers for coupling the ultrasound to the hose-accommodating device and ensures a high signal output.

According to a preferred aspect of the present invention the periphery of the forming duct is smaller than that of the undeformed hose. Thus the periphery of the elastic hose material can be compressed. During compression a force is produced which presses the hose wall against the forming areas. This ensures in a simple manner that there are no air inclusions in the traveling path of the ultrasonic signal.

According to a preferred aspect of the present invention at least one stamp movable transversely to the hose is provided, said stamp deformingly pressing the hose such that the hose is in tight surface contact with the forming areas. This leads to the desired compression of the hose periphery. One movable stamp is normally sufficient. However two stamps moving in opposite directions may be provided, the stamps moving towards each other upon closing of the forming duct in order to cause transverse expansion of the hose and thus tight surface contact of the hose with the forming areas of the forming channel. The ultrasonic transmitter and the ultrasonic receiver are preferably arranged at a distace to the hose inner wall, which corresponds to a multiple of (2 n−1) . . . λλ/4, wherein λλ indicates the wavelength of the ultrasonic signals in the medium concerned, and n is an integer. At this distance an acoustical impedance matching is attained at which the relative sound transmissivity reaches its maximum.

According to a special aspect of the present invention a means is provided which determines a characteristic quantity of the hose material from the signal level of the received signal in the case of bubble-free transmission. This aspect of the present invention makes use of the realization that different hose materials and hose wall thicknesses lead to a dislocation of the focal point and/or an acoustical impedance mismatching. This results in signal attenuations which allow conclusions to be drawn with regard to the hose material used. This parameter is of interest with respect to medical pumps since the hose material used has a considerable influence on the pump characteristic. Thus the ultrasonic sensor can further be used to analyze the material or the quality of an inserted hose.

### BRIEF DESCRIPTION OF THE DRAWINGS

Hereunder an embodiment of the present invention is explained in detail with reference to the drawings in which:

FIG. 1 shows a schematic representation of the ultrasonic sensor, and

FIG. 2 shows a representation of the geometric conditions of the ultrasonic sensor.

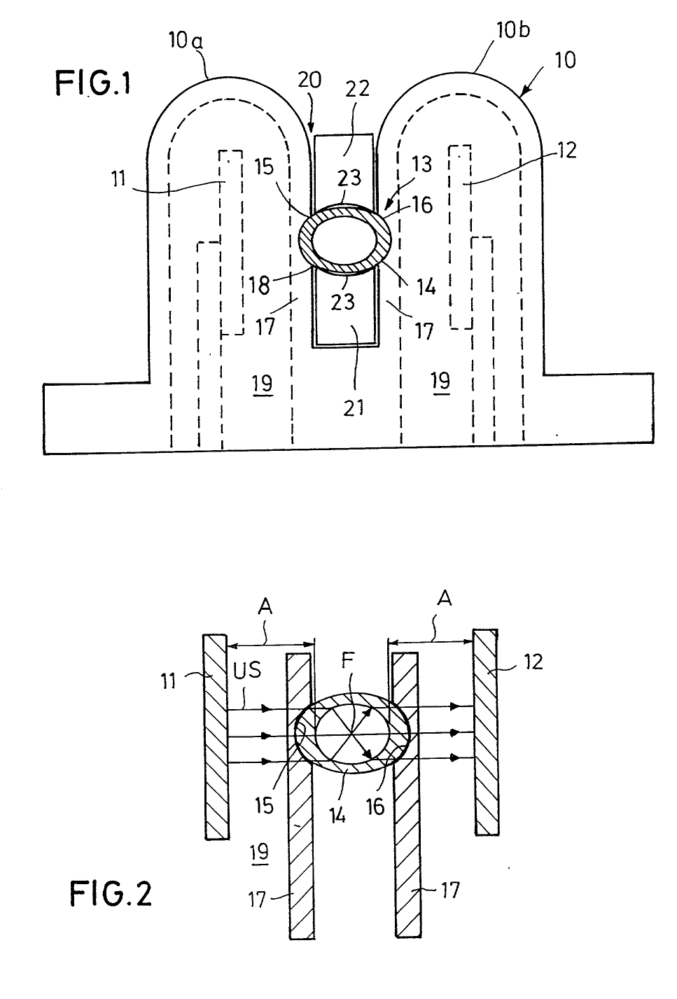

### DESCRIPTION OF THE PREFERRED EMBODIMENT

The ultrasonic sensor comprises a housing 10 containing an ultrasonic transmitter 11 and an ultrasonic receiver 12. The ultrasonic transmitter 11 and the ultrasonic receiver 12 each comprise a piezoelectric crystal. The piezoelectric crystal of the ultrasonic transmitter 11 is excited by an electrical vibration circuit (not shown) such that it transmits ultrasonic signals. The ultrasonic signals are received by the ultrasonic receiver 12 and converted into electrical signals.

Between the ultrasonic transmitter 11 and the ultrasonic receiver 12 an accommodating device 13 for accommodating a hose 14 is provided. The accommodating device 13 comprises rigid concave forming areas 15, 16 formed in the respective wall 17 of the housing 10. The forming areas 15, 16 are located opposite each other. They are part of a forming channel 18 in which the hose 14 is forcedly formed into an ellipse.

The interior of the housing 10 between the the ultrasonic transmitter 11 and the wall 17 is filled with artificial resin 19, e. g. an epoxy resin. Here the housing 10 is made from PVC.

The sound velocities in the wall 17 and in the plastic material 19 are almost identical and amount to 2500 m/sec. The sound velocity in the material of the hose 14 is approximately the same as that in the wall 17 and in the plastic material 19 and amounts here to 2530 m/sec. The sound velocity in the liquid passing through the hose 14 is approximately 1400 m/sec.

The ultrasonic transmitter and the ultrasonic receiver are accommodated in different housing portions 10a, 10b between which a gap 20 is provided which is defined by the walls 17. In the gap 20 two stamps 21, 22 are arranged which can press against the hose 14 from opposite sides and form the hose into an ellipse whose bending areas are pressed against the forming areas 15, 16. Each stamp 21 and 22 has a thin or concave bearing surface 23.

The hose 14 is inserted into the guide channel 18 when the stamps 21 and 22 are in the retracted position. Then the stamps 21 and 22 are moved towards each other thus compressing the hose 14 and tightly pressing it against the forming areas 15, 16. In this condition ultrasound is guided through the hose lumen.

FIG. 2 shows the course of the ultrasound US transmitted by the ultrasonic transmitter 11. The ultrasound travels in parallel beams though the plastic material 19, the wall 17 and the hose 14. When reaching the interface inside the hose, the ultrasonic beams are diffracted and concentrated onto a focal point f. Behind the focal point the ultrasonic beams diverge again and are then parallelled at the interface inside the hose and impinge onto the ultrasonic receiver 12. Although the three ultrasonic beams shown pass through different geometric lengths, they arrive in phase at the ultrasonic receiver 12. Therefore no phase-produced cancellations take place.

The focal depth f of the acoustical lens formed by the curved interface between the hose inner wall and the liquid amounts to

f=r/(1−c2/c1),

where r is the radius of curvature of the hose, c1 the sound velocity in the liquid and c2 the sound velocity in the hose material.

The radius of curvature of the forming areas 15, 16 is selected such that parallel sound waves are refracted in direction to the hose center when they pass through the first interface between hose and liquid, and are formed into parallel sound waves again when they pass through the second interface. By focusing the sound energy into the hose and onto the receiver the received signal is intensified such that the generated electrical signal can be rectified by diodes without any signal intensification being required. Since the sound waves impinge almost vertically onto the ultrasonic receiver when the pass through the second interface and are formed into parallel sound waves again, the occurrence of reflections and interferences is prevented.

The distance A between ultrasonic transmitter and interface should be an odd-numbered multiple of λλ/4, i. e. (2n−1) . . . λλ/4, where n is an integer. λλ is the sound velocity in the plastic material 19 and/or the wall 17.

Although a preferred embodiment of the invention has been specifically illustrated and described herein, it is to be understood that minor variations may be made without departing from the spirit and scope of the invention, as defined in the appended claims.

What is claimed is:

1. Ultrasonic sensor for detecting gas bubbles in a hose (14) comprising an ultrasonic transmitter (11) and an ultrasonic receiver (12) arranged on opposite sides of an accommodating device (13) for the hose (14), wherein the accommodating device (13) comprises rigid concave forming areas (15, 16) defining a forming channel (18) with an essentially oval cross-section.

2. Ultrasonic sensor according to claim 1, wherein the periphery of the forming channel (18) is smaller than that of the undeformed hose (14).

3. Ultrasonic sensor according to claim 1, wherein at least one stamp (21, 22) movable transversely to the hose (14) is provided, which stamp deformingly presses the hose (14) such that it is in tight surface contact with the forming areas (15, 16).

4. Ultrasonic sensor according to claim 3, wherein at least one stamp (21, 22) comprises a concave bearing surface (23) for the hose (14), the radius of the bearing surface being larger than that of the forming areas (15, 16).

5. Ultrasonic sensor according to claim 1, wherein between the ultrasonic transmitter (11) and one forming area (15), and between the ultrasonic receiver (12) and the other forming area (16) a solid-matter material (19) is arranged in which the traveling velocity of ultrasound is approximately identical with the traveling velocity of ultrasound in the material of the hose (14).

6. Ultrasonic sensor according to claim 1, wherein the distance between the ultrasonic transmitter (11) and/or the ultrasonic receiver (12) on the one hand and the hose inner wall on the other hand amounts to an odd-numbered multiple of λλ/4, wherein λλ is the wavelength of the ultrasonic vibration.

7. Ultrasonic sensor according to claim 1, wherein a means is provided which determines a characteristic quantity from the signal level of the signals received by the ultrasonic receiver (12) in the case of bubble-free transmission.

8. Ultrasonic sensor according to claim 1, wherein each forming area (15, 16) deforms the hose (14) such that the interface between the hose and the liquid contained therein forms a focusing acoustical lens.
